(19) United States
(12) Patent Application Publication
(10) Pub. No.: US 2011/0292664 A1
(43) Pub. Date: Dec. 1, 2011

(54) ANGLE ADJUSTING MECHANISM FOR STREETLAMP

(75) Inventor: Cheng-Chao Jong, Taoyuan (TW)

(73) Assignee: JENN FENG NEW ENERGY CO., LTD., Taoyuan (TW)

(21) Appl. No.: 12/788,657

(22) Filed: May 27, 2010

(51) Int. Cl. F21V 19/02

(52) U.S. Cl. 362/418

(57) ABSTRACT

An angle adjusting mechanism for a streetlamp includes a housing connected with a lamp, and an angle positioning board and a lamppost sleeve installed in the housing. The angle positioning board has a first positioning hole and a plurality of second positioning holes. The lamppost sleeve has a first positioning tube and a second positioning tube. Through pre-arranging corresponding angles of the angle positioning board and the lamppost sleeve, the illumination angle of the lamp is capable of being adjusted. Moreover, the lamppost sleeve and the angle positioning board are fastened by screws, so the illumination angle of the lamp and the housing can be rapidly adjusted through loosening or fastening the screws.

### BACKGROUND OF THE INVENTION

1. Field of the Invention

The present invention relates to an angle adjusting mechanism for a streetlamp, more particularly to a mechanism that is simple in structure and capable of rapidly finishing angle adjustment.

2. The Prior Arts

As shown in FIG. 1, a conventional streetlamp capable of adjusting illumination angle includes a housing A, a lamppost sleeve seat installed in the housing, an angle adjusting structure (not shown) installed to connect the housing A and the lamppost sleeve seat, and a lamp C installed at the exterior of the housing A. The angle of the lamp C can be adjusted with the housing A by the angle adjusting structure so as to adjust the illumination angle. The lamppost sleeve seat includes a sleeve B for receiving a lamppost and the position of the sleeve B is corresponding to an opening A1 arranged at an end of the housing A. For adjusting angles of the housing A and the lamp together, the opening A1 is often fabricated as an oval-shaped opening having a diameter larger than the outer diameter of the sleeve B, thereby reserving a space in which a movement can be performed.

A general streetlamp installed by a roadside for illumination substantially consists of a lamp being directly installed on a top end of a lamppost, and the illumination angle is predetermined according to the location to be illuminated. Then, the lamp is fixed on the lamppost by screws.

The disadvantage of the general streetlamp is that the illumination angle is fixed, so a reflection or a refraction type lamp with a fixed illumination angle is hard to be adjusted to different illumination angles. Therefore, the application of the streetlamp is not flexible.

### SUMMARY OF THE INVENTION

A primary objective of the present invention is to provide an angle adjusting mechanism for a streetlamp that is capable of adjusting various illumination angles according to different illumination requirements so as to achieve an optimal illumination. Another objective of the present invention is to provide an angle adjusting mechanism for a streetlamp that is simple in structure and is capable of rapidly adjusting the streetlamp to various illumination angles.

For achieving the aforementioned objectives, an angle adjusting mechanism for a streetlamp according to the present invention comprises a housing and a lamp is connected to an exterior of the housing. An opening is defined on an end of the housing opposite to the end where the lamp is installed. At least one pair of positioning tubes is disposed on a bottom surface of the housing and each of the positioning tubes has a first inner thread hole. At least one angle positioning board is installed in the housing. Both ends of the angle positioning board include a first positioning hole and a plurality of second positioning holes, respectively. Two fastening portions are vertically extended from two ends of the top of the angle positioning board, respectively. Each of the fastening portions has a fastening hole corresponding to the first inner thread hole. A lamppost sleeve is sleeved on a lamppost. The outer diameter of the lamppost sleeve is smaller than that of the opening of the housing, and the lamppost sleeve is disposed corresponding to the opening. A first positioning tube and a second positioning tube are formed on a surface of the lamppost sleeve, and the second positioning tube has a first engaging portion and a second engaging portion. The second engaging portion and the first positioning tube are on the same horizontal level, and an intersection angle is defined between the horizontal level and a line connecting the second engaging portion and the first engaging portion. The first positioning tube and the second positioning tube are both provided with a second inner thread hole. The first positioning hole is corresponding to the second inner thread hole of the first positioning tube.

The angle adjusting mechanism for a streetlamp according to the present invention overcomes the disadvantages of conventional arts. Furthermore, the structure of the angle adjusting mechanism is simple and can easily adjust and enhance illumination range and effect of the streetlamps installed in various places.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a schematic view of a conventional adjustable streetlamp;

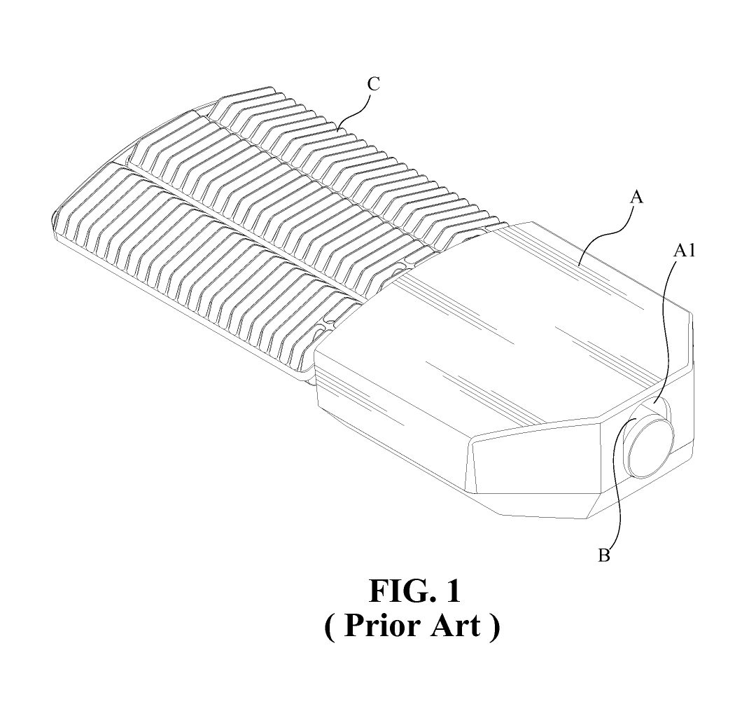

FIG. 2 is a schematic view of an angle adjusting mechanism for a streetlamp according to the present invention;

FIG. 3 is an exploded view of the angle adjusting mechanism for streetlamp according to the present invention;

FIG. 4 is a schematic view illustrating the angle adjusting mechanism for streetlamp according to the present invention being at zero degree angle;

FIG. 5 is a schematic view illustrating the angle adjusting mechanism for streetlamp according to the present invention being at 2.5 degree angle;

FIG. 6 is a schematic view illustrating the angle adjusting mechanism for streetlamp according to the present invention being at 5 degree angle.

### DETAILED DESCRIPTION OF THE PREFERRED EMBODIMENT

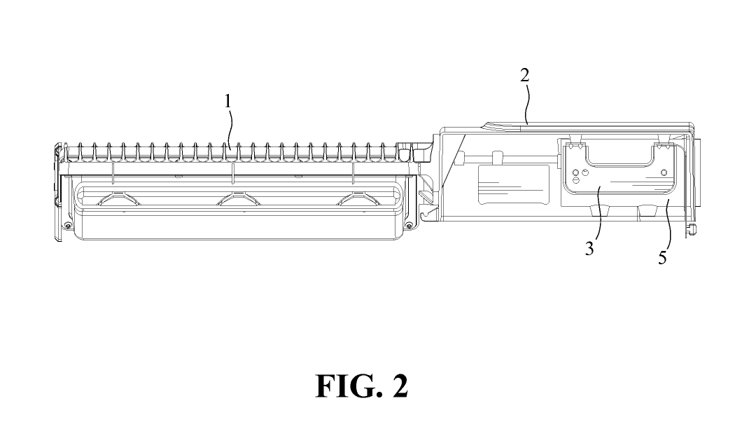

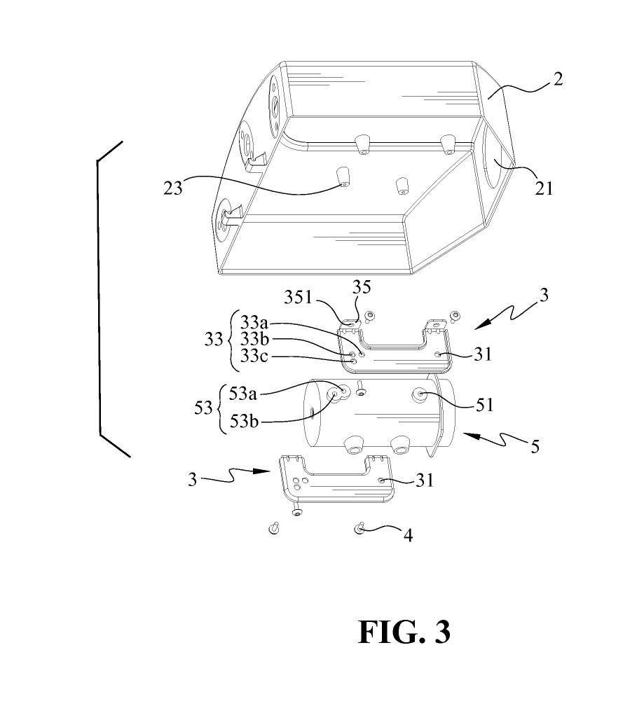

Referring to FIGS. 2 and 3, wherein FIG. 2 is a schematic side view showing an angle adjusting mechanism for a streetlamp according to an embodiment of the present invention and FIG. 3 is an exploded view showing the angle adjusting mechanism for the streetlamp according to the present invention.

The angle adjusting mechanism for the streetlamp according to present invention comprises a housing 2 and a lamp 1 is connected to an exterior of the housing 2. An opening 21 is formed on an end of the housing 2 opposite to an end where the lamp 1 is connected. A bottom surface of the housing 2 includes at least one pair of positioning tubes 23 and each of the positioning tubes 23 has a first inner thread hole. As shown in FIG. 3, two pairs of positioning tubes 23 according to the preferred embodiment are provided on the bottom surface of the housing 2 and respectively disposed at two sides of the opening 21. It is noted that the positioning tubes 23 are always provided in pair on the bottom surface of the housing 2. The quantity and the installed location of the positioning tubes 23 are with respect to the actual needs. The quantity and installed location of the positioning tubes 23 mentioned above are served as an embodiment and not as a limitation for the present invention.

At least one angle positioning board 3 is mounted in the housing 2. Both ends of the angle positioning board 3 include a first positioning hole 31 and a plurality of second positioning holes 33, respectively. Two fastening portions 35 are perpendicularly extended from both ends of a top of the angle positioning board 3, respectively. The fastening portions are installed oriented toward a side wall of the housing. Each of the fastening portions 35 has a fastening hole 351. Both of the fastening portions 35 are provided corresponding to the pair of the positioning tubes 23, and the fastening holes 351 of the fastening portions 35 are provided corresponding to the first inner thread holes of the positioning tubes 23. The fastening holes 351 of the fastening portions 35 are aligned with the first inner thread holes of the positioning tubes 23, and the fastening portions 35 are connected with the positioning tubes 23 by screws 4. Therefore, the angle positioning board 3 is mounted to the bottom surface of the housing 2. According to the preferred embodiment, two of the angle positioning boards 3 is installed to two pairs of the positioning tubes 23, respectively.

A lamppost sleeve 5 is sleeved on a lamppost (not shown). An outer diameter of the lamppost sleeve 5 is smaller than that of the opening 21 of the housing 2, and the lamppost sleeve 5 is disposed corresponding to the opening 21 of the housing 2. A first positioning tube 51 and a second positioning tube 53 are formed on a surface of the lamppost sleeve 5.

The second positioning tube 53 is substantially shaped in FIG. 8 and has a first engaging portion 53a and a second engaging portion 53b. The second engaging portion 53b and the first positioning tube 51 are disposed on the same horizontal level. An intersection angle is defined between the horizontal level and a line connecting the second engaging portion 53b and the first engaging portion 53a. The first positioning tube 51 of the lamppost sleeve 5 has a second inner thread hole and is disposed corresponding to the first positioning hole 31 of the angle positioning board 3. A screw 4 connects the second inner thread hole of the first positioning tube 51 with the first positioning hole 31. The angle of the angle positioning board 3 is adjustable. The first engaging portion 53a and the second engaging portion 53b of the lamppost sleeve 5 are corresponding to the second positioning holes 33 of the angle positioning board 3. The first engaging portion 53a and the second engaging portion 53b are capable of connecting with one of the corresponding second positioning holes 33. When it needs to adjust the illumination angle of the lamp 1, just adjust the angle of the angle positioning board 3. Because the housing 2 is fixed with the angle positioning board 3, the angle of the housing 2 is the same as that of the angle positioning board 3. Therefore, through pre-arranging corresponding angles of the first positioning hole 31 and the second positioning holes 33 of the angle positioning board 3 and the first positioning tube 51 and the second positioning tube 53 of the lamppost sleeve 5, the illumination angle of the lamp 1 is capable of being adjusted. Moreover, the lamppost sleeve 5 and the angle positioning board 3 are fastened by the screws 4, so the angle adjustment of the lamp 1 and the housing 2 can be rapidly finished through loosening or tightening screws.

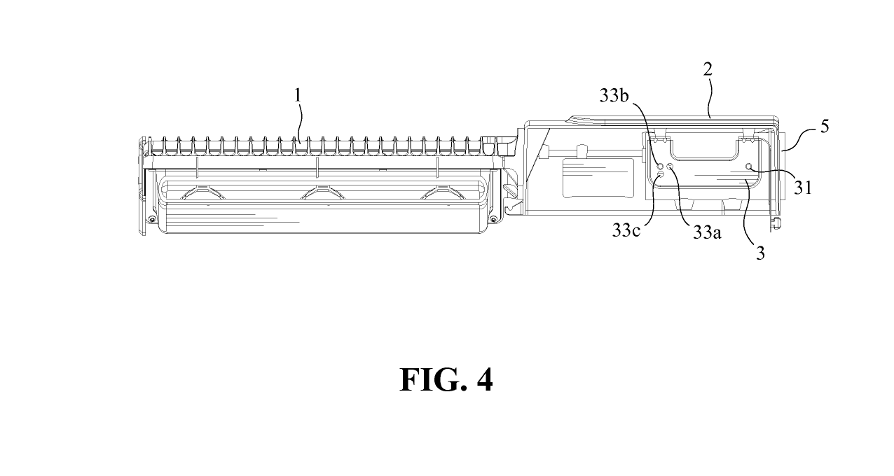

Referring to FIG. 4, the angle adjusting mechanism for the streetlamp according to the present invention is set at a zero degree angle. Referring to FIGS. 3 and 4, the second positioning holes 33 of the angle positioning board 3 further include a third positioning hole 33a, a fourth positioning hole 33b and a fifth positioning hole 33c, and the aforementioned second positioning holes 33 are arranged in an L shape. Firstly, the housing 2 and the lamp 1 are adjusted together to be horizontal, so the fourth positioning hole 33b and the first positioning hole 31 are located at a horizontal level. The screws 4 fasten the fourth positioning hole 33b and the first positioning hole 31 with the second engaging portion 53b and the first positioning tube 51, respectively. Thus, the lamp is adjusted to a zero degree angle from horizontal position.

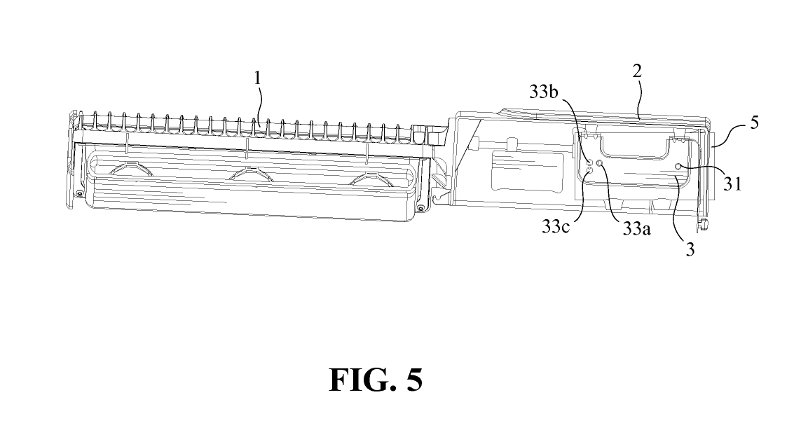

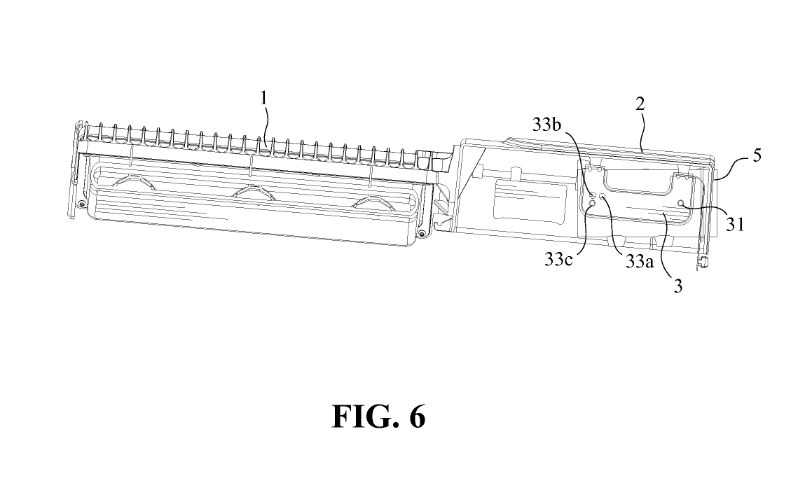

Referring to FIGS. 3 and 5, the housing 2 and the lamp 1 are together adjusted to an angle, so that the third positioning hole 33a and the first positioning hole 31 are aligned with the first engaging portion 53a and the first positioning tube 51, respectively. The screws 4 connect the third positioning hole 33a and the first positioning hole 31 with the first engaging portion 53a and the first positioning tube 51, respectively. Thus, the lamp 1 is adjusted to a 2.5 degree angle from horizontal position. Referring to FIGS. 3 and 6, the housing 2 and the lamp 1 are together adjusted to an angle, so that the fifth positioning hole 33c and the first positioning hole 31 are aligned with the second engaging portion 53b and the first positioning tube 51, respectively. The screws 4 connect the fifth positioning hole 33c and the first positioning hole 31 with the second engaging portion 53b and the first positioning tube 51, respectively. Thus, the lamp 1 is adjusted to a 5 degree angle from horizontal position.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. An angle adjusting mechanism for a streetlamp, comprising:
a housing connected with a lamp, an opening defined on an end of the housing opposite to an end where the lamp is connected, at least one pair of positioning tubes disposed on a bottom surface of the housing, each of the positioning tubes having a first inner thread hole;
at least one angle positioning board installed in the housing, both ends of the angle positioning board respectively including a first positioning hole and a plurality of second positioning holes, both ends of a top of the angle positioning board perpendicularly extended with a fastening portion, each of the fastening portions having a fastening hole corresponding to the first inner thread hole; and
a lamppost sleeve for being sleeved on a lamppost, the lamppost sleeve having an outer diameter smaller than that of the opening of the housing, so that the lamppost sleeve being disposed corresponding to the location of the opening, a first positioning tube and a second positioning tube formed on a surface of the lamppost sleeve, the second positioning tube having a first engaging portion and a second engaging portion, the second engaging portion and the first positioning tube disposed on a same horizontal level, an intersection angle defined between the horizontal level and a line connecting the second engaging portion and the first engaging portion, each of the first positioning tube, the first engaging portion and the second engaging portion having a second inner thread hole, the first positioning holes being corresponding to the second inner thread holes of the first positioning tube;
wherein through adjusting the angles of the housing and the lamp together, one of the second positioning holes is aligned with one of the first engaging portion and the second engaging portion of the second positioning tube, and the first inner thread holes and the second inner thread holes are capable of being fastened with screws.

2. The angle adjusting mechanism as claimed in claim 1, wherein the fastening portions are installed oriented toward a side wall of the housing.
